(19) United States
(12) Patent Application Publication
(10) Pub. No.: US 2017/0316060 A1
(43) Pub. Date: Nov. 2, 2017

(54) DISTRIBUTED EXECUTION OF HIERARCHICAL DECLARATIVE TRANSFORMS

(71) Applicant: Microsoft Technology Licensing, LLC, Redmond, WA (US)

(72) Inventors: Shantanu Kiran Pakhare, Redmond, WA (US); Reza Shojaei, Kirkland, WA (US); Brandyn Michael Phelps, Seattle, WA (US); Radu Gruian, Sammamish, WA (US)

(21) Appl. No.: 15/199,612

(22) Filed: Jun. 30, 2016

Related U.S. Application Data
(60) Provisional application No. 62/329,094, filed on Apr. 28, 2016.

(51) Int. Cl. G06F 17/30

(52) U.S. Cl. CPC G06F 17/30528; G06F 17/30867

(57) ABSTRACT

Delegating queries within a transformation chain that match delegable query patterns associated with external services. One or more matches between one or more delegable query patterns associated with one or more external services and one or more queries included within the transformation chain are identified. Execution of the one or more identified queries is then delegated to the one or more external services. Upon execution of the one or more identified queries, one or more results associated with the execution are then received. Once the one or more results have been received, the results are implemented within the transformation chain.

### CROSS-REFERENCE TO RELATED APPLICATION

This application claims the benefit of U.S. Provisional Patent Application Ser. No. 62/329,094 filed Apr. 28, 2016, which provisional patent application is incorporated herein by reference in its entirety.

### BACKGROUND

Software programs, or applications, enable computer systems to obtain a high degree of functionality. Through the use of mobile computers, phones, and tablets, software applications have become an integral part of the way many individuals live and work. Software applications consist of computer-executable instructions that have been developed by one or more individuals and/or computer systems. For an individual to acquire the necessary skill and experience to create complex software development, generally years of education and experience and required.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to delegating queries within a transformation chain that match delegable query patterns associated with external services. For example, embodiments may include identifying one or more matches between one or more delegable query patterns associated with one or more external services and one or more queries included within the transformation chain. Execution of the one or more identified queries is then delegated to the one or more external services. Upon execution of the one or more identified queries, one or more results associated with the execution are then received. Once the one or more results have been received, the results are implemented within the transformation chain.

Accordingly, queries/operations associated with nodes of a transformation chain may be intelligently delegated to external services rather than being executed on devices that are inherently limited with respect to processing capabilities (e.g., smart phones, tablets, and so forth). Furthermore, the results of the remote execution may be combined with results from locally executed portions to create a final result that is usable by a local host device.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer system in which the principles described herein may be employed.

FIG. 2 illustrates the transformation of a transformation chain into a series of code snippets.

FIG. 3 illustrates an exploded view of a transformation chain node.

FIG. 4 illustrates the use of a distributable pattern library to identify supported query patterns.

FIG. 5 illustrates the use of a query builder to generate code.

FIG. 6 illustrates the delegation of multiple identified delegable queries.

FIG. 7 illustrates a flow chart of an example method for delegating queries within a transformation chain that match delegable query patterns associated with external services.

### DETAILED DESCRIPTION

At least some embodiments described herein relate to delegating queries within a transformation chain that match delegable query patterns associated with external services. For example, embodiments may include identifying one or more matches between one or more delegable query patterns associated with one or more external services and one or more queries included within the transformation chain. Execution of the one or more identified queries is then delegated to the one or more external services. Upon execution of the one or more identified queries, one or more results associated with the execution are then received. Once the one or more results have been received, the results are implemented within the transformation chain.

Accordingly, queries/operations associated with nodes of a transformation chain may be intelligently delegated to external services rather than being executed on devices that are inherently limited with respect to processing capabilities (e.g., smart phones, tablets, and so forth). Furthermore, the results of the remote execution may be combined with results from locally executed portions to create a final result that is usable by a local host device.

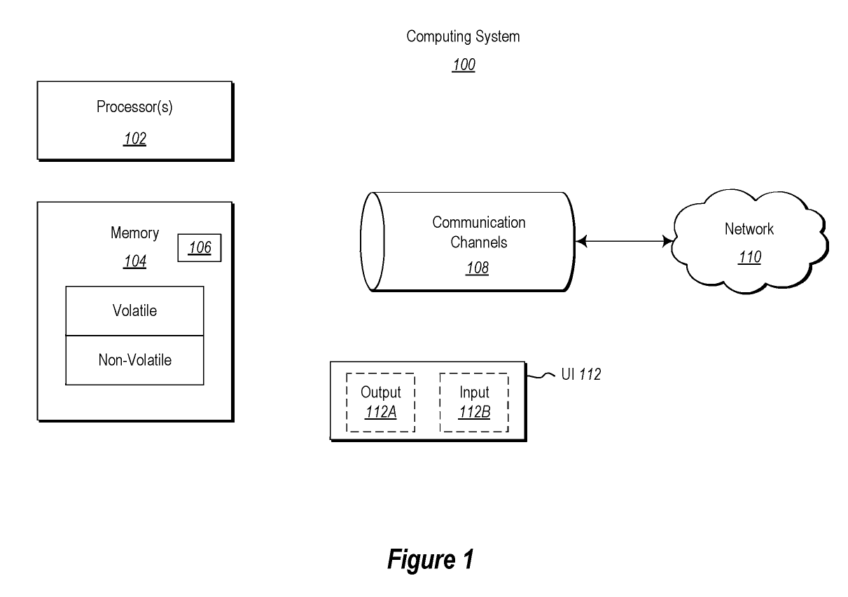

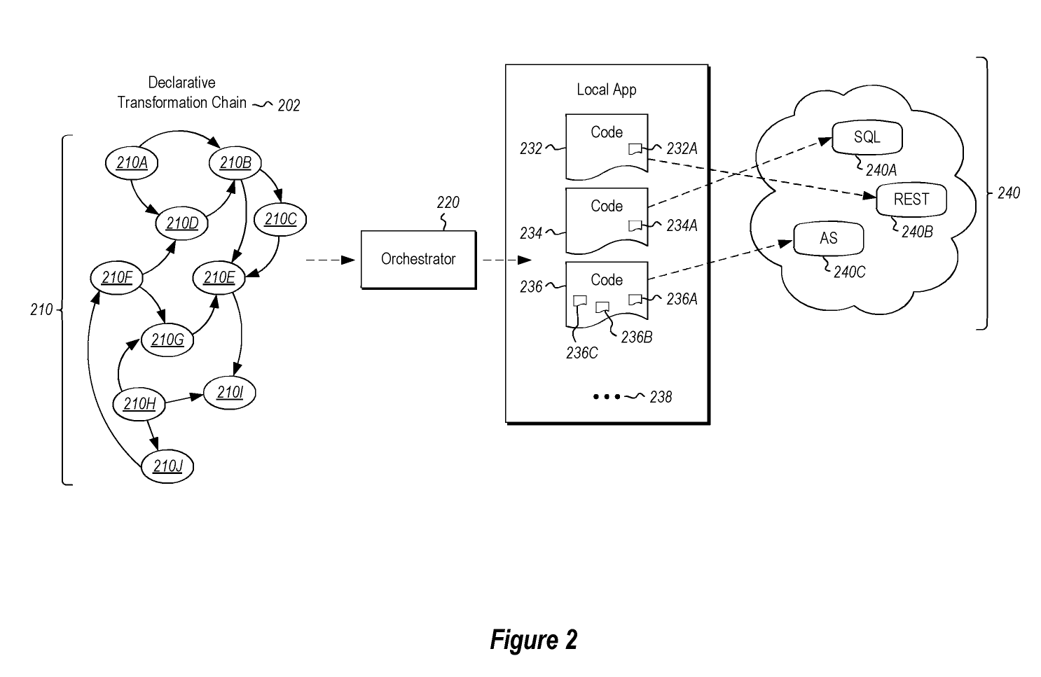

Because the principles described herein operate in the context of a computing system, a computing system will first be described with respect to FIG. 1, as an enabling technology for the principles described herein. Thereafter, further details regarding delegating queries within a transformation chain that match delegable query patterns associated with external services will be described with respect to FIGS. 2 through 7.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses, watches, bands, and so forth). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

Each of the depicted computer systems is connected to one another over (or is part of) a network, such as, for example, a Local Area Network (“LAN”), a Wide Area Network (“WAN”), and even the Internet. Accordingly, each of the depicted computer systems as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

The computing system 100 has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “controller”, “validator”, “runner”, “deployer”, “orchestrator”, “builder” or the like, may also be used. As used in this description and in the case, these terms (regardless of whether the term is modified with one or more modifiers) are also intended to be synonymous with the term “executable component” or be specific types of such an “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth. In accordance with the principles describe herein, alerts (whether visual, audible and/or tactile) may be presented via the output mechanism 112A.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that readable media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses or watches) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

The principles described herein operate using a transformation chain (also referred to herein as a dependency chain, dependency graph, and transformation graph). A transformation chain is an interconnected set of nodes (also referred to herein as entities) that each may represent data sources or data sinks. There are links between the nodes, each link representing a transformation. For any given link, the associated transformation receives copies of values of one or more data sources situated at an input end to the link, and generates resulting values being provided at one or more data sinks located at the output end of the link. For any given transformation, when a value at one or more of the data sources at its input end changes, the transformation is automatically reevaluated, potentially resulting in changes in value(s) of one or more data sinks at the output end of the transformation.

In one embodiment, regardless of how complex the transformation chain is, the transformations may be constructed from declarative statements expressing equations, rules, constraints, simulations, or any other transformation type that may receive one or more values as input and provide the resulting one or more values as output. Transformation chains may be augmented as a program is built by linking different transformation chains to honor the dependencies between the chains. Portions of transformation chains may also be delegated to other devices and/or users.

A transformation chain of nodes, as described, may be used as a model for a computer application that allows those with little, or no, software development experience to create other computer applications. For example, the nodes may be comprised of visual entities (e.g., buttons, sliders, tables, MICROSOFT EXCEL® tables, MICROSOFT OFFICE tables, Structured Query Language (“SQL”) Tables, MICROSOFT OFFICE 365 Proxies, and so forth) included within such a created computer application. A node may be considered to be dependent on another node when a sink has to be reevaluated, recomputed, and so forth, in circumstances where the source of that dependency changes.

An example of such dependencies may be found in spreadsheet software applications (e.g., MICROSOFT EXCEL). In such applications, when one cell is modified, it may have an impact on one or more other cells (which in turn could impact still other cells, and so forth). In another example, a created application may have a button that when interacted with, may cause other nodes within the created application to be re-evaluated, re-calculated, and so forth. Accordingly, the entire transformation chain may be updated as necessary.

Each node may be annotated with transforms that are declarative/functional pieces of logic. For example, such transforms may be comprised of formulas/expressions. Such transforms may specify how data is manipulated/reshaped when it flows into the node. Furthermore, if a node is inherently visual, such a node may react in visual ways when data flows into the node. For example, a slider having a bar and a handle, may include the handle changing positions with respect to the bar when data input is received at the slider. Similarly, the handle may also output data when the handle's position is manually changed (e.g., the handle's position with respect to the bar is changed by a user).

The transformation chain may be a dataflow execution model that represents how a created application will behave (i.e., what you see is what you get—“WYSIWYG”). Accordingly, the nodes and dependencies may be materialized as code, which may be done incrementally. Thus, during the creation of an application, the transformation chain associated with the created application may change shape (e.g., connections of nodes to other nodes and data may change throughout the creation process). Ultimately, the code that is generated as part of a created application may run on a host device (e.g., smart phone, tablet, laptop, and so forth) as the created application (i.e., the created application may have a user interface with which a user can interact, perform various functions/services, and so forth).

Orchestrating a seamless distribution of the transformation chain may include various steps. For example, delegable query patterns that can be executed remotely and asynchronously may be identified. A specialized query builder that can handle the queries that have delegable query patterns may then be used to communicate with remote servers/services to execute the delegable queries. Non-delegable queries may then execute on a host device (e.g., phone, tablet, laptop, and so forth) while delegable queries may execute remotely. Accordingly, the results of all queries (both delegable and non-delegable) may be seamlessly reintegrated and composed into a final result that the created application may use.

As illustrated, FIG. 2 includes nodes that are collectively referred to as nodes 210, and together form declarative transformation chain. While 10 different nodes 210 are illustrated as forming transformation chain, there may be any number of nodes that form a transformation chain. FIG. 2 also includes an orchestrator 220 that may incrementally transform the transformation chain into a series of generated snippets of code (i.e., code snippet 232, code snippet 234, and code snippet 236). While only three code snippets are shown, ellipses 238 demonstrate that there may be any number of generated code snippets.

The code snippets may comprise any language (e.g., JAVASCRIPT®) that can run both locally on a device (phone, tablet, laptop, desktop, and so forth) and within web/cloud computing environments. Some of the code snippets may have segments (i.e., segment 232A, segment 234A, segment 236A, segment 236B, and segment 236C) within the code snippets that are delegable, such that execution of the segments may be delegated to various external servers/services 240 (e.g., SQL SERVER®, REST API, and so forth) in the cloud. Once again, while FIG. 2 illustrates between one and three delegable segments per code snippet, there may be any number of delegable segments within a code snippet, including as few as zero. The external servers/services 240 may then be instructed to execute various delegable segments, as described more fully herein. The results of the remotely executed segments are then seamlessly reincorporated back into the created application.

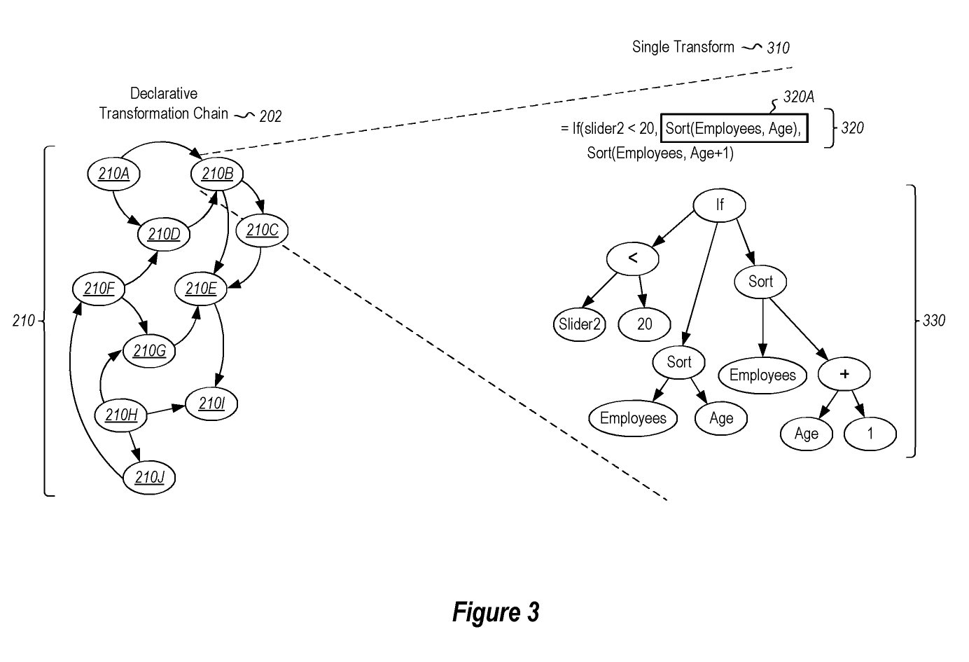

FIG. 3 illustrates node 210B in an exploded view of a single declarative transform included within the node 210B. As described briefly herein, the transform may include a declarative expression similar to one that would be included in a spreadsheet software application (e.g., MICROSOFT EXCEL, APPLE NUMBERS®, GOOGLE SHEETS™, and so forth). As shown, the expression 320 comprises “=If(slider2<20, Sort(Employees, Age), Sort (Employees, Age+1)).” FIG. 3 also includes delegable portion 320A of the expression 320. The highlighted query 320 (also referred to herein as operation, query pattern, pattern, or schema) shown FIG. 3 may be identified as comprising a delegable query pattern. Accordingly, delegable portion 320A includes a query pattern that can execute on one of the remote servers/services 240. However, the other sort function query pattern (i.e., age+1) may not be delegable and will thus execute on the host device.

The first step to performing the overall process described herein may include encoding queries included within a transformation chain in some form (e.g., encoded using a tree structure, a directed acyclic graph (“DAG”) structure, and so forth). As illustrated in FIG. 3, the expression 320 of node 210B may be encoded using tree structure 330. The encoded queries may then be matched against encoded query patterns that can be executed by external servers/services, as described more fully herein. In some embodiments, the result upon execution of such an expression (i.e., expression 320) may be sent to a visual input that has the ability to show tabular data. Accordingly, depending on the value of “slider2,” employees may be sorted by age or employees may be sorted by age+1. Regardless of how the data is sorted, the results may be sent to, and used by, the visual input (i.e., the results may be displayed on a user interface (UI) of a software application associated with a transformation chain).

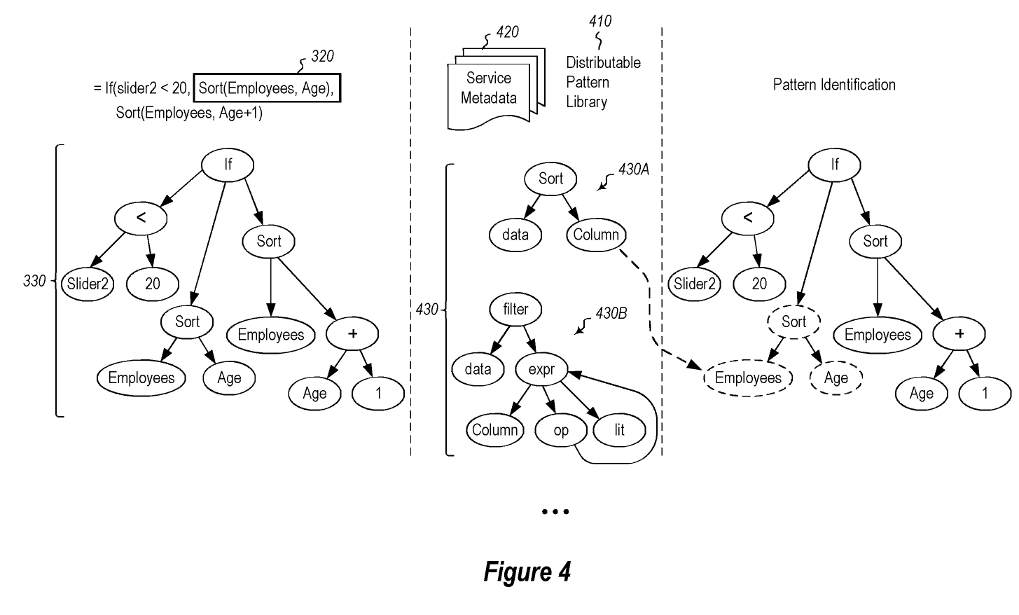

FIG. 4 illustrates the use of a distributable pattern library 410 that consists of metadata 420 associated with a particular external service 240. Each supported service 240 (e.g., SQL service/connector, MICROSOFT EXCEL connector, and so forth) may include metadata 420 (e.g., JSON-based metadata) that identifies what operations are supported by the particular service and some of the requirements for delegating queries. Accordingly, each individual service 240 may publish the query patterns that the service supports. The query patterns can then be encoded in a similar fashion to the queries included within a transformation chain by using any applicable structure (e.g., tree structures, DAG structures, or any other applicable structure).

While FIG. 4 illustrates two supported encoded query patterns 430, which include sort query pattern 430A and filter query pattern 430B, any number of query patterns may be supported by a particular service 240. Accordingly, metadata associated with the query patterns that are supported by the services may be published by the services. The supported query patterns (and/or their associated metadata) may then be encoded to create graph structures having query patterns that can be matched to identified and encoded queries within a transformation chain.

In some embodiments, nodes in the transformation chain that represent tabular data sources, (e.g., data included in MICROSOFT EXCEL tables or SQL tables) may be tagged with data store-provided metadata that indicates a set of capabilities. For example, capabilities may include the ability to sort or filter the data with respect to specific columns. A graph structure of queries within a created application may be annotated with properties that measure the compatibility with the capabilities of available services. Based on these properties, various algorithms may be used to identify specific portions of the graph structure whose execution can be distributed by delegating to other devices, remote stores, remote servers, and so forth (e.g., services). For example, pattern matching algorithms that operate on tree or DAG structures can be employed to identify supported/delegable query patterns of a transformation chain that have been encoded into a tree or DAG structure.

Accordingly, as illustrated in FIG. 4, the queries within tree-based representation 330 (e.g., query patterns found within a created application) may be identified/matched with query patterns 430 that have been identified by a particular service as being queries that are delegable to the particular service. In some embodiments, the matching may be done by a local pattern identifier (i.e., local to the host device smart phone, tablet, laptop) that can identify all of the query patterns supported by an available service and match one or more to queries found in the transformation chain.

FIG. 4 illustrates one match between the queries found in the transformation (e.g., created application) and the query patterns supported by at least one service. As shown, query pattern 430A has been identified as matching a query within tree-based representation 330. The identified/matched query may then be delegated to the service that supports the identified query pattern 430A. In some cases, there may be more than one service that supports a particular query pattern. As such, there may be some logic built-in that determines which service to use in such instances, as described more fully herein. Regardless of whether more than one service supports a particular query pattern, once the query has been delegated to a particular service, that service executes the query remotely (i.e., remotely as it relates to the local host device).

In some embodiments, it may be determined that certain delegable queries are not to be delegated for various reasons, including the server/host is offline, delegation is estimated to take longer than local execution, the server to which a query would be delegated is currently operating within a peak usage time, and so forth. However, it may generally be advantageous to delegate. For example, the external servers to which delegation may occur can generally deal with a lot more data, more quickly process the data, and more efficiently process the data than the local host device. In other words, the external servers may have state of the art architecture/algorithms and may be built specifically to deal with the type of queries and/or operations (e.g., sorting, filtering, joining, grouping, etc.) being delegated.

Accordingly, a decision may be made as to whether a query is to be delegated, which may be based on a variety of factors (e.g., complexity of the operation, condition of the server, estimated execution time, and so forth). In some embodiments, all queries having query patterns that match the patterns placed in the distributable pattern library, are all delegated. In other words, the decision to delegate particular operation/query patterns may be made at the time the pattern is placed within the distributable pattern library.

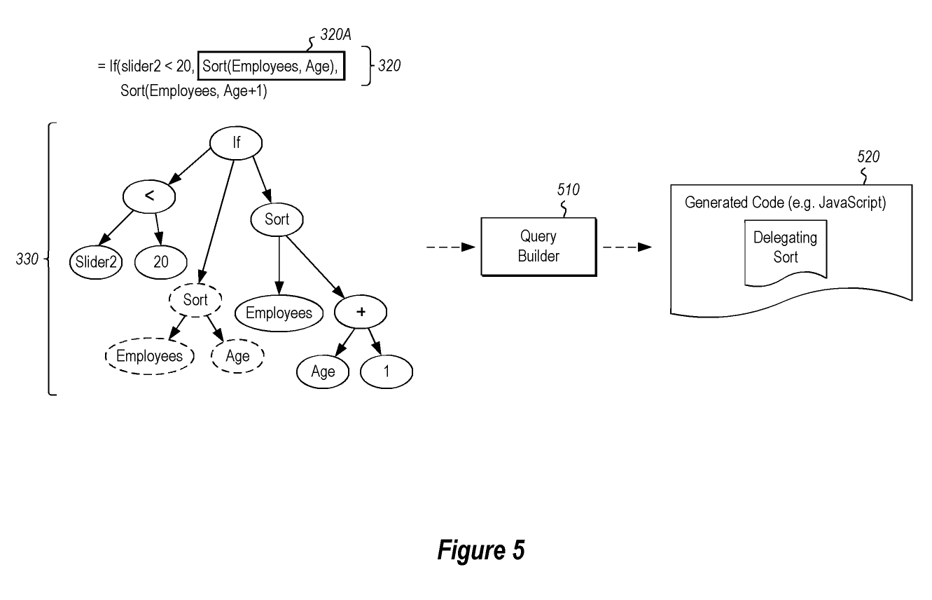

As illustrated in FIG. 5, the identified queries within tree-based representation 330, including both delegable and non-delegable queries are then run through query builder 510, which results in composite generated code 520. The generated code 520 may comprise JAVASCRIPT or any other language that is portable between local devices and web/cloud computing environments. The generated code 520 may be an executable representation of queries (within tree-based representation 330) that delegates all identified delegable portions (e.g., delegable sort operation 320A) to the applicable remote services. For instance, Open Data Protocol (“ODATA”) queries, SQL scripts, or DATA ANALYSIS EXPRESSIONS (“DAX”) queries may be generated to encode and schedule the remote execution of identified delegable portions of queries.

The generated code 520 (i.e., an executable representation) may combine the results of both the remotely executed portions (i.e., the delegable queries) and the locally executed portions. This combination may be used to provide a coherent result on the local host device, based on the tree-based representation of the particular expression or declarative transform (i.e., If(slider2<20, Sort(Employees, Age), Sort(Employees, Age+1)), as shown in FIG. 4).

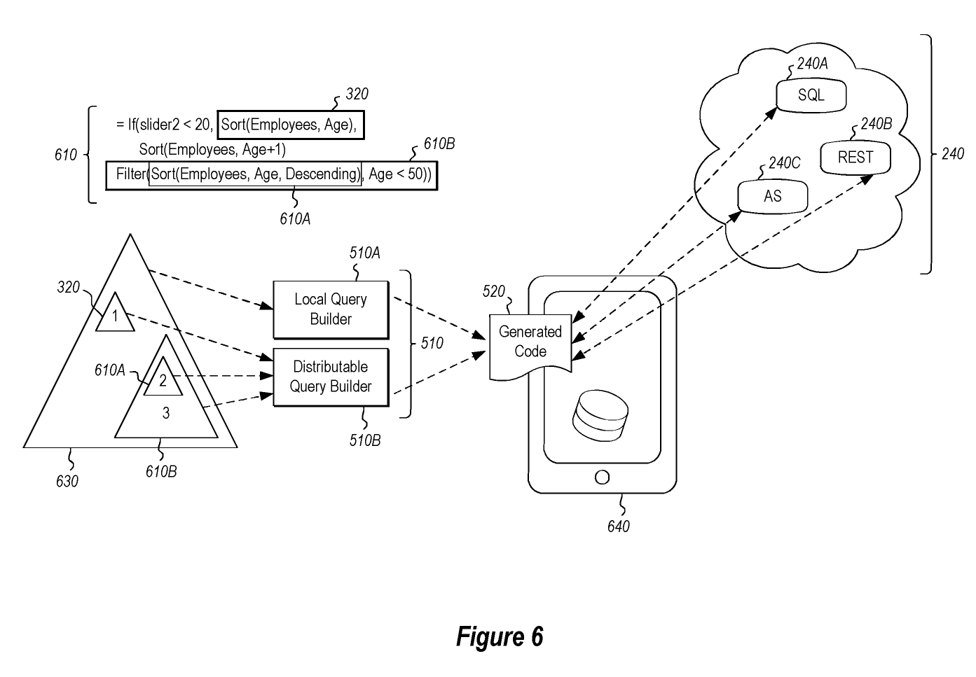

As illustrated in FIG. 6, two separate query builders 510 may be used, one for delegable query patterns (i.e., distributable query builder 510B) and one for non-delegable query patterns (i.e., local query builder 510A). As such, local query builder 510A is capable of running the logic for non-delegable query patterns (or delegable patterns that are determined to not be delegated) locally. On the other hand, distributable query builder 510B is capable of delegating and communicating with an external service 240 in order to execute queries having delegable patterns.

While FIGS. 4 and 5, and their associated descriptions, relate to a single transform, FIG. 6 illustrates multiple transforms. For example, FIG. 6 illustrates an expression 610 that includes delegable sort operation 320 and a delegable sort operation 610A (i.e., descending with age) within a delegable filter operation 610B (i.e., relating to ages less than 50). Accordingly, multiple queries having delegable query patterns may be delegated. Triangle 630 is a representation of expression 610, similar to the tree-based representation 330. As shown, triangles 320, 610A, and 610B represent delegable sort operation 320, delegable sort operation 610, and delegable filter operation 620, respectively, all of which comprise queries having delegable patterns (i.e., patterns supported by external services)

As briefly described herein, the delegable queries 320, 610A, and 610B may be handled by the distributable query builder 510B, while the rest of the queries (i.e., the rest of the triangle) may be handled by the local query builder 510A. The distributable query builder 510B may also include the logic necessary to know the order of dependencies of delegable operations/queries. For example, in FIG. 6, it may be possible to execute delegable operations 320 and 610A in parallel. However, delegable operation 610B may depend on delegable operation 610A, thus operation 610B will wait for operation 610A to execute.

The distributable query builder 510B may further follow the order of operations of particular programming languages used (e.g., “sort” and “filter” operations may be run in parallel, but “if statements” may branch, thus stopping particular operations from running in parallel). Furthermore, separate services may also be able to execute separate operations at the same time for the same created application (e.g., one operation in SQL, one operation in MICROSOFT AZURE™, one operation in AMAZON WEB SERVICES® (“AWS”), and so forth). Accordingly, the distributable query builder 510B may provide more efficiency in execution of a created application's queries by intelligently instructing separate external services 240 to execute separate queries of the created application. Some of the data that is used for executing the delegable queries may, however, be owned by a service (e.g., SQL table). In such cases, while there may be some representation of the data on the local host device, the actual data may be stored in the cloud on the particular server/service (e.g., an SQL SERVER).

While the delegable queries are being executed externally, the generated code from the non-delegable queries may run on the local host device (e.g., phone, tablet, desktop, and so forth), which will communicate, as necessary, with the external services 240 (e.g., SQL, REST API, and so forth) that are executing any delegable queries. All of the results (i.e., both the results executed locally and the results executed remotely) may then be combined into the generated code to provide a result that can be used by the created application running on the local host device 640.

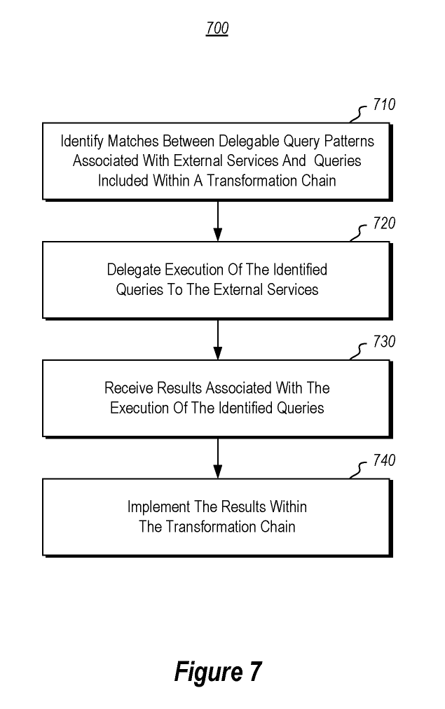

FIG. 7 illustrates a flowchart of a method 700 for delegating queries within a transformation chain that match delegable query patterns associated with external services. The method 700 includes identifying one or more matches between one or more delegable query patterns associated with one or more external services and one or more queries included within a transformation chain (Act 710). For example, a sort operation associated with a node of a transformation chain may be identified as matching a query pattern supported by an external service. Identifying the matches may also include first encoding both the delegable query patterns and the queries included within the transformation chain in a tree-based graph or a DAG.

Once the one or more matches have been identified, execution of the one or more identified queries may be delegated to the one or more external services (Act 720). For example, execution of the identified match of the sort operation to a supported query pattern may then be delegated to an external service that performs such operations. One or more results associated with the execution of the one or more identified queries may then be received (Act 730). For instance, the result of the sort operation's execution may then be received. Once the one or more results have been received they may be implemented within the transformation chain (Act 740). Implementing the results within the transformation may include reevaluating the entire transformation chain, potentially resulting in changes in values of one or more outputs of the transformation chain. For example, a transformation chain may be associated with a created software application. As such, when the one or more results are implemented, the software may have an associated user interface (UI) that displays the received results or modifies the UI in some manner.

In this way, queries/operations associated with nodes of a transformation chain may be intelligently delegated to external services rather than being executed on devices that are inherently limited with respect to processing capabilities (e.g., smart phones, tablets, and so forth). Furthermore, the results of the remote execution may be combined with results from locally executed portions to create a final result that is usable by a local host device.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A computer system, comprising:
one or more processors; and
one or more computer readable storage media having stored thereon computer-executable instructions that are executable by the one or more processors to cause the computer system to delegate queries within a transformation chain that match delegable query patterns associated with external services, the computer-executable instructions including instructions that are executable to cause the computer system to perform at least the following:
identify one or more matches between one or more delegable query patterns associated with one or more external services and one or more queries included within the transformation chain;
delegate execution of the one or more identified queries to the one or more external services;
receive one or more results associated with the execution of the one or more identified queries; and
implement the one or more results within the transformation chain.

2. The computer system of claim 1, wherein the transformation chain comprises a plurality of nodes.

3. The computer system of claim 1, wherein the transformation chain is associated with a software application.

4. The computer system of claim 1, wherein at least one of the one or more queries comprises a declarative expression.

5. The computer system of claim 1, wherein implementing the one or more results within the transformation chain comprises displaying the one or more results on a user interface (UI) of a software application associated with the transformation chain.

6. The computer system of claim 1, wherein one or more non-delegable queries included within the transformation chain are identified, the one or more non-delegable queries comprising queries having query patterns that are not supported by at least one external source.

7. The computer system of claim 6, wherein the one or more non-delegable queries are executed locally.

8. The computer system of claim 7, wherein results from execution of the non-delegable queries and results from execution of the delegable queries are combined into a single result that is implemented within the transformation chain.

9. The computer system of claim 1, further comprising encoding the one or more queries included within the transformation chain before identifying the one or more matches between the one or more delegable query patterns and the one or more queries.

10. The computer system of claim 9, wherein the one or more queries are encoded using at least one of a tree structure and a directed acyclic graph (DAG) structure.

11. The computer system of claim 10, further comprising encoding the one or more delegable query patterns associated with the one or more external services before identifying the one or more matches between the one or more delegable query patterns and the one or more queries.

12. The method of claim 11, wherein the one or more delegable query patterns are encoded using the same structure used to encode the one or more queries.

13. A method, implemented at a computer system that includes one or more processors, for delegating queries within a transformation chain that match delegable query patterns associated with external services, the method comprising:
identifying one or more matches between one or more delegable query patterns associated with one or more external services and one or more queries included within a transformation chain;
delegating execution of the one or more identified queries to the one or more external services;
receiving one or more results associated with the execution of the one or more identified queries; and
implementing the one or more results within the transformation chain.

14. The method of claim 13, further comprising identifying one or more non-delegable queries included within the transformation chain, the one or more non-delegable queries comprising queries having query patterns that are not supported by at least one external source.

15. The method of claim 14, further comprising executing the one or more non-delegable queries locally.

16. The method of claim 13, further comprising encoding the one or more queries included within the transformation chain before identifying the one or more matches between the one or more delegable query patterns and the one or more queries.

17. The method of claim 16, wherein the one or more queries are encoded using at least one of a tree structure and a directed acyclic graph (DAG) structure.

18. The method of claim 17, further comprising encoding the one or more delegable query patterns associated with the one or more external services before identifying the one or more matches between the one or more delegable query patterns and the one or more queries.

19. The method of claim 18, wherein the one or more delegable query patterns are encoded using the same structure used to encode the one or more queries.

20. A method, implemented at a computer system that includes one or more processors, for delegating queries within a transformation chain that match delegable query patterns associated with external services, the method comprising:
encoding one or more queries included within the transformation chain and one or more delegable query patterns associated with one or more external services;
using the one or more encoded queries and the one or more encoded delegable query patterns to identify one or more matches between the one or more delegable query patterns and the one or more queries;
delegating execution of the one or more queries identified as matches to the one or more external services;
receiving one or more results associated with the execution of the one or more queries identified as matches; and
implementing the one or more results within the transformation chain.
